(19) United States
(12) Patent Application Publication
(10) Pub. No.: US 2021/0289681 A1
(43) Pub. Date: Sep. 23, 2021

(54) PROTECTIVE SHIN AND SIDE PLATE FOR A TILLAGE SHANK WITH ADJUSTABLE DEPTH FERTILIZER TUBE

(71) Applicant: Jeffery M. Reynolds, Corfu, NY (US)

(72) Inventor: Jeffery M. Reynolds, Corfu, NY (US)

(21) Appl. No.: 17/190,952

(22) Filed: Mar. 3, 2021

Related U.S. Application Data
(63) Continuation-in-part of application No. 16/047,228, filed on Jul. 27, 2018, now Pat. No. 10,993,362.
(60) Provisional application No. 62/543,517, filed on Aug. 10, 2017.

(51) Int. Cl. A01B 15/02; A01B 35/22; A01B 15/06

(52) U.S. Cl. CPC A01B 15/025; A01B 15/06; A01B 35/225

(57) ABSTRACT

A side plate configured for a tillage shank having a point on a forward edge of the tillage shank and a point base on a bottom edge of the tillage shank to dampen abrasive forces from soil flow includes a modified side plate extension portion having a modified side plate extension portion front edge, the modified side plate extension portion being configured such that the modified side plate extension portion front edge abuts a rear edge of the point on the forward edge of the tillage shank from the point base on the bottom edge of the tillage shank to above a soil line; an attachment portion having an attachment portion front edge, the attachment portion being configured such that the attachment portion front edge does not abut the rear edge of the point on the forward edge of the tillage shank above the soil line; a projection configured to engage the point base; a slot configured to engage the point base; and an opening configured to receive a transverse bolt.

### PRIORITY INFORMATION

The present application is a continuation-in-part of co-pending U.S. patent application Ser. No. 16/047,228, filed on Jul. 27, 2018; said U.S. patent application Ser. No. 16/047,228, filed on Jul. 27, 2018, claiming priority, under 35 U.S.C. § 119(e), from U.S. Provisional Patent Application, Ser. No. 62/543,517, filed on Aug. 10, 2017. The entire content of U.S. patent application Ser. No. 16/047,228, filed on Jul. 27, 2018, is hereby incorporated by reference.

The present application claims priority, under 35 U.S.C. § 119(e), from U.S. Provisional Patent Application, Ser. No. 62/543,517, filed on Aug. 10, 2017. The entire content of U.S. Provisional Patent Application, Ser. No. 62/543,517, filed on Aug. 10, 2017, is hereby incorporated by reference.

### BACKGROUND

Conventional tillage shanks have been provided with a delivery tube for the purpose of placing fertilizer or other substance below the surface of the ground at the same time the moving shank is cutting through and working the soil. Some conventional shank assemblies include a tube that has been permanently welded to the shank at a fixed location. In other conventional situations, the farmer may obtain tubes separately from the shanks and then weld the tubes to the shanks.

A problem with the welded-on design is that if the farmer desires to apply fertilizer at different depths in varying conditions, the farmer must change the depth of the shank as well, whether changing the shank depth is optimum for the situation at hand or not. Some conventional units provide fertilizer tubes that can be adjusted relative to the shank, but such adjustments are difficult to make and are time-consuming.

Another example of a conventional tillage shank having a delivery tube for the purpose of placing fertilizer or other substance below the surface of the ground at the same time the moving shank is cutting through and working the soil is illustrated in FIGS. 1 and 2.

As illustrated in FIGS. 1 and 2, shank assembly 12 includes an elongated, generally upright, slightly rearwardly inclined, flat shank 24 that is adjustably supported by a horizontal frame 26 of device 10 for selective positioning in any one of a number of vertically adjusted positions. Shank 24 is rectangular in transverse cross-section, having a flat front edge 28, a flat rear edge 30, and a pair of wide, flat, left and right sides 32. Shank 24 also has a lowermost bottom edge and is provided with a rearwardly facing notch 38 (FIG. 6) in rear edge 30 near bottom edge.

Shank assembly 12 further includes a point or shoe broadly denoted by the numeral 40 and detachably secured to shank 24. Point (shoe) 40 is designed to make the primary contacting engagement with the soil along front edge 28 instead of shank 24 so as to avoid premature wear of front edge 28 of shank 24. Thus, point (shoe) 40 is constructed of a hardened material and is designed to be a replaceable (consumable) unit.

Point (shoe) 40 is generally L-shaped when viewed in a side elevation and includes a generally horizontal leg comprising a base 42 and a generally upright leg comprising a front edge guard 44. The point (shoe) 40 also includes a rear edge 45. Guard 44, rear edge 45, and base 42 are integrally connected parts of a single, L-shaped unit.

Guard 44 of point (shoe) 40 is slightly wider than front edge 28 of shank 24, and rear edge 45 of point (shoe) 40 butts up against front edge 28 when point (shoe) 40 is in place. A generally upright beveled leading edge 46 of guard 44 serves to cut through the soil in the slit made by a coulter 16 and to progressively widen such slit to permit the passage therethrough of the remaining width of shank assembly 12.

As illustrated in FIGS. 1 and 2, base 42 has a relatively broad, flat chisel nose 48 that progressively transitions to leading edge 46. Base 42 is also substantially wider than guard 44 and shank 24 so as to present a pair of shelf-like wing portions that lead rearwardly from chisel nose 48 and project laterally outwardly from opposite sides of shank 24. Immediately behind guard 44 within base 42 is a centrally disposed opening (not shown) that receives the lower end portion of shank 24 and through which bottom edge projects.

A rear cross bar (not shown) defines the rear extremity of the opening and spans the two opposite wing portions of base 42 behind the opening. Notch 38 (FIG. 6) in shank 24 receives the rear cross bar so as to properly locate base 42 relative to the lower end of shank 24 and to provide a sturdy interconnection therebetween.

At the upper end of guard 44, point (shoe) 40 is held on shank 24 by a transverse bolt 54 passing through shank 24 and a pair of ears 56 that project rearwardly from guard 44 and embrace opposite sides of shank 24.

Shank assembly 12 further includes a pair of generally L-shaped, flat, side shield plates 58 and 60 held on opposite sides 32 of shank 24. Plates 58 and 60 are disposed in such a position relative to shank 24 that plates 58 and 60 project rearwardly beyond shank rear edge 30 and cooperatively define a gap or generally U-shaped channel 62 (FIG. 2) immediately behind rear edge 30. Such gap 62 is adapted to receive and protectively house a pair of generally upright delivery tubes 64 and 66 for fertilizer or other substances.

Side plates 58 and 60 each have a rear margin 68 that projects rearwardly beyond rear shank edge 30 for use in defining the gap 62. Additionally, each rear margin 68 includes a generally vertically extending series of rectangular holes (70) that serve as part of the means for adjustably supporting tubes 64 and 66 as explained in more detail below.

The upper ends of side plates 58 and 60 are secured to shank 24 by a common transverse bolt 72 at a location determined to be normally above the surface of the ground when the shank assembly is in use.

A downwardly projecting tab 74 (FIG. 2) at the lower extremity of each side plate 58, 60 fits into a corresponding side notch 76 (FIG. 2) in the opening to help in retaining the side plate interlocked with base 42.

A second downwardly projecting tab 78 (FIG. 2) at the lower end of each side plate 58 and 60 is spaced rearwardly from front tab 74 and is received within a rearwardly opening recess 80 (FIG. 2) in the rear end of base 42 immediately behind the rea cross bar. The lower ends of side plates 58 and 60 are securely held in place and interlocked with base 42 without the use of transverse fasteners or the like passing through shank 24 and projecting outwardly beyond the outer surfaces of plates 58, 60 in a region that would be susceptible to abrasive wear from the soil.

As illustrated in FIGS. 1 and 2, a pair of fertilizer tubes 64 and 66 is included.

Front tube 64 is generally C-shaped, presenting an upper inlet end 82 that projects upwardly and rearwardly from rear edge 30 of shank 24 for connection with a delivery hose or the like (not shown) from a source of material supply. A straight, intermediate portion 84 of tube 64 lies generally against rear edge 30, and an outturned lower end 86 of tube 64 serves as a discharge end thereof.

Tube 64 is conventionally constructed of metal, but that is not a requirement. Welded or otherwise secured to the rear face of intermediate tube portion 84 is a generally I-shaped, flat retainer 88 having a pair of upper oppositely projecting projections 106, 110 (FIG. 2) and a pair of lower oppositely projecting projections 90 and 94 (FIG. 2). Projections 90, 94, 106, and 110 are shaped complementally with respect to holes 70 and are selectively receivable within a corresponding vertically spaced pair of such holes.

In a similar manner, rear tube 66, which is shorter in overall length than tube 64, is generally C-shaped and has an upper, outturned inlet end 98 adapted to be coupled with a hose or other conduit (not shown) leading from a source of material supply. A straight intermediate portion 100 is adapted to be disposed within gap 62 behind the line of holes 70, and an outturned, lower discharge end 102 directs materials into the ground. Tube 66 is conventionally constructed of metal, although such is not required.

Side plates 58 and 60 each have a front projection 105 that extends towards the rear edge 45 of the point (shoe) 40. The front projection 105 has a lower front edge 103 that abuts the rear edge 45 of the point (shoe) 40 when the side plates 58 and 60 and the point (shoe) 40 engaged the shank 24.

Conventionally, the lower front edge 103 abuts the rear edge 45 of the point (shoe) 40 at the bottom portion of the point (shoe) 40 such that the lower front edge 103 does not extend from the base 42 beyond the lowest outturned lower discharge end of a fertilizer tube. As illustrated in FIG. 2, the lower front edge 103 abuts the rear edge 45 of the point (shoe) 40 at the bottom portion of the point (shoe) 40 such that the front edge 103 does not extend from the base 42 beyond the outturned lower discharge end 86 of fertilizer tube 64.

Moreover, side plates 58 and 60 each have an upper front edge 108. Conventionally, the upper front edge 108 does not abut the rear edge 45 of the point (shoe) 40 such that the upper front edge 108 extends from the lowest outturned lower discharge end of a fertilizer tube to the transverse bolt 72. As illustrated in FIG. 2, upper front edge 108 does not abut the rear edge 45 of the point (shoe) 40 and extends from the outturned lower discharge end 86 of fertilizer tube 64 to the transverse bolt 72.

As illustrated in FIGS. 1 and 2, the area 300 of the shank 24 behind the point (shoe) 40 and in front of the side plates 58 and 60 is subject to abrasive forces as the soil flows over the shank in this area.

More specifically, the valley shape of the area 300 causes the forward edge of the side plates 58 and 60 (shields for the fertilizer tubes) to be subjected to the abrasive forces, thereby negatively impacting the integrity of the side plates 58, 60 (shields for the fertilizer tubes), eventually allowing abrasive forces of the soil to enter the fertilizer (material) delivery tube “chamber” and negatively impact the integrity of the actual fertilizer tubes.

Moreover, due to the non-smooth surface from the shank 24 to the front of the side plates 58 and 60, the valley (300) causes turbulence in the soil flow, further increasing the abrasive forces therefrom.

The abrasive forces of the soil flow causes a farmer to utilize (consume) more side plates (shield) per tip or shoe.

In other words, a farmer replaces the side plates (shields) multiple times due to loss of integrity from the abrasive forces of the soil flow before the farmer needs to replace the tip or shoe due to loss of integrity from the abrasive forces of the soil flow.

A conventional solution to counteracting or dampening the abrasive force of the soil flow has been to weld the leading edge of the side plates 58 and 60 (shields for the fertilizer tubes) to the shank 24.

This conventional solution requires many man hours and requires the removal of the shank from the tractor to make the necessary welds.

The welding solution reduces the number of times that the side plates (shields) need to be replaced per tip or shoe replacement; however, the side plates (shields) still need to be replaced more often than the tip or shoe.

Therefore, it is desirable to provide a solution to counteract or dampen the abrasive force of the soil flow which does not require many man hours to implement.

Moreover, it is desirable to provide a solution to counteract or dampen the abrasive force of the soil flow which does not require the removal of the shank from the tractor to realize the implementation of the solution.

Furthermore, it is desirable to provide a solution to counteract or dampen the abrasive force of the soil flow which extends the life of the side plates (shields) to be substantially equal to the life of the tip or shoe.

In addition, it is desirable to provide a solution to counteract or dampen the abrasive force of the soil flow which does not require many man hours to implement, does not require the removal of the shank from the tractor to realize the implementation of the solution, and extends the life of the side plates (shields) to be substantially equal to the life of the tip or shoe.

### BRIEF DESCRIPTION OF THE DRAWINGS

The drawings are only for purposes of illustrating various embodiments and are not to be construed as limiting, wherein:

FIG. 1 illustrates a conventional tillage device;

FIG. 2 illustrates the shank assembly of FIG. 1;

FIG. 3 illustrates a shank assembly with a consumable protection shin;

FIG. 4 shows a side perspective of the consumable protection shin of FIG. 3;

FIG. 5 shows a perspective of the consumable protection shin of FIG. 4 along dotted line 5;

FIG. 6 shows a modified shank for a tillage device;

FIG. 7 illustrates another embodiment of a shank assembly with a consumable protection shin;

FIG. 8 shows a side perspective of the consumable protection shin of FIG. 7;

FIG. 9 shows a perspective of the consumable protection shin of FIG. 8 along dotted line 9;

FIG. 10 shows a perspective of another embodiment of the consumable protection shin of FIG. 8 along dotted line 9;

FIG. 11 illustrates a modified side plate configured to counteract or dampen the abrasive forces of the soil flow;

FIG. 12 shows a perspective of the modified side plate of FIG. 11 along dotted line A;

FIG. 13 shows a perspective of the modified side plate of FIG. 11 along dotted line B; and

FIG. 14 shows the shank assembly of FIG. 2 with a modified side plate configured to counteract or dampen the abrasive forces of the soil flow.

### DETAILED DESCRIPTION

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts may be properly illustrated.

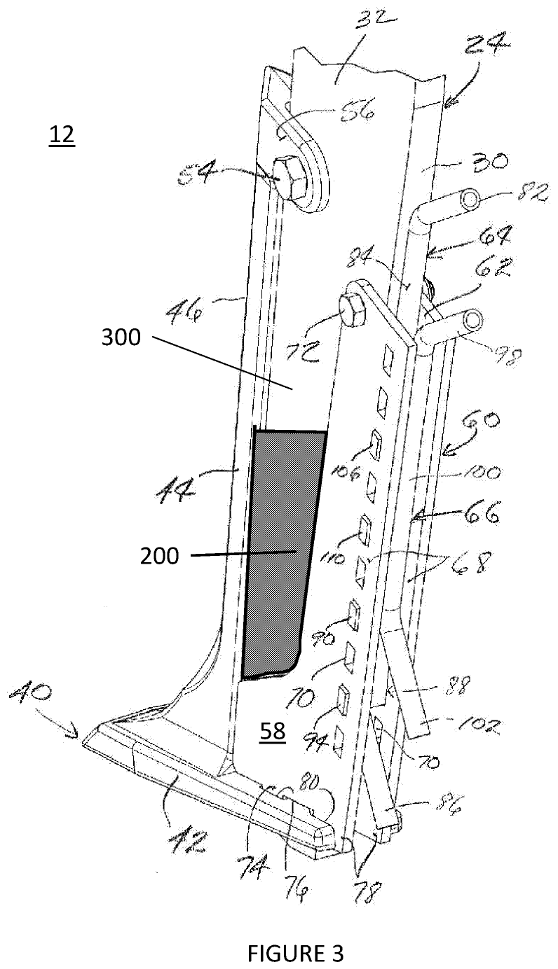

FIG. 3 illustrates a shank assembly 12 that includes an elongated, generally upright, slightly rearwardly inclined, flat shank 24. Shank 24 is rectangular in transverse cross-section, having a front edge, a flat rear edge 30, and a pair of wide, flat, left and right sides 32.

Shank assembly 12 further includes a point or shoe broadly denoted by the numeral 40 and detachably secured to shank 24. Point (shoe) 40 is designed to make the primary contacting engagement with the soil instead of shank 24 so as to avoid premature wear of shank. Thus, point (shoe) 40 is constructed of a hardened material and is designed to be a replaceable (consumable) unit.

Point (shoe) 40 is generally L-shaped when viewed in side elevation and includes a generally horizontal leg comprising a base 42 and a generally upright leg comprising a front edge guard 4 4. Guard 44 and base 42 are integrally connected parts of a single, L-shaped unit.

Guard 44 is slightly wider than front edge of shank 24 and butts up against front edge of shank 24 when point (shoe) 40 is in place. A generally upright beveled leading edge 46 of guard 44 serves to cut through the soil and to progressively widen such cut to permit the passage therethrough of the remaining width of shank assembly 12.

As illustrated in FIG. 3, base 42 has a relatively broad, flat chisel nose that progressively transitions to leading edge 46. Base 42 is also substantially wider than guard 44 and shank 24 so as to present a pair of shelf-like wing portions that lead rearwardly from the chisel nose and project laterally outwardly from opposite sides of shank 24.

At the upper end of guard 44, point (shoe) 40 is held on the shank 24 by a transverse bolt 54 passing through shank 24 and a pair of ears 56 that project rearwardly from guard 44 and embrace opposite sides of shank 24.

Shank assembly 12 further includes a pair of generally L-shaped, flat, side shield plates 58 and 60 held on opposite sides of the shank 24. Side shield plates 58 and 60 are disposed in such a position relative to shank 24 that the side shield plates project rearwardly beyond shank rear edge 30 and cooperatively define a gap or generally U-shaped channel 62 immediately behind rear edge 30. Such gap 62 is adapted to receive and protectively house a pair of generally upright delivery tubes 64 and 66 for fertilizer or other substances.

Side shield plates 58 and 60 each have a rear margin 68 that projects rearwardly beyond rear shank edge 30 for use in defining the gap 62. Additionally, each rear margin 68 includes a generally vertically extending series of rectangular holes 70 that serve as part of the means for adjustably supporting tubes 64 and 66.

The upper ends of side shield plates 58 and 60 are secured to shank 24 by a common transverse bolt 72 at a location determined to be normally above the surface of the ground when the shank assembly is in use.

As illustrated in FIG. 3, a pair of fertilizer tubes 64 and 66 is included.

Front tube 64 is generally C-shaped, presenting an upper inlet end 82 that projects upwardly and rearwardly from rear edge 30 of the shank 24 for connection with a delivery hose or the like (not shown) from a source of material supply. A straight, intermediate portion 84 of tube 64 lies generally against rear edge 30, and an outturned lower end 86 of tube 64 serves as a discharge end thereof.

Tube 64 is conventionally constructed of metal, but that is not a requirement. Welded or otherwise secured to the rear face of intermediate tube portion 84 is a generally I-shaped, flat retainer 88.

In a similar manner, rear tube 66, which is shorter in overall length than tube 64, is generally C-shaped and has an upper, outturned inlet end 98 adapted to be coupled with a hose or other conduit (not shown) leading from a source of material supply. A straight intermediate portion 100 is adapted to be disposed within gap 62 behind the line of holes 70, and an outturned, lower discharge end 102 directs materials into the ground. Tube 66 is conventionally constructed of metal, although such is not required.

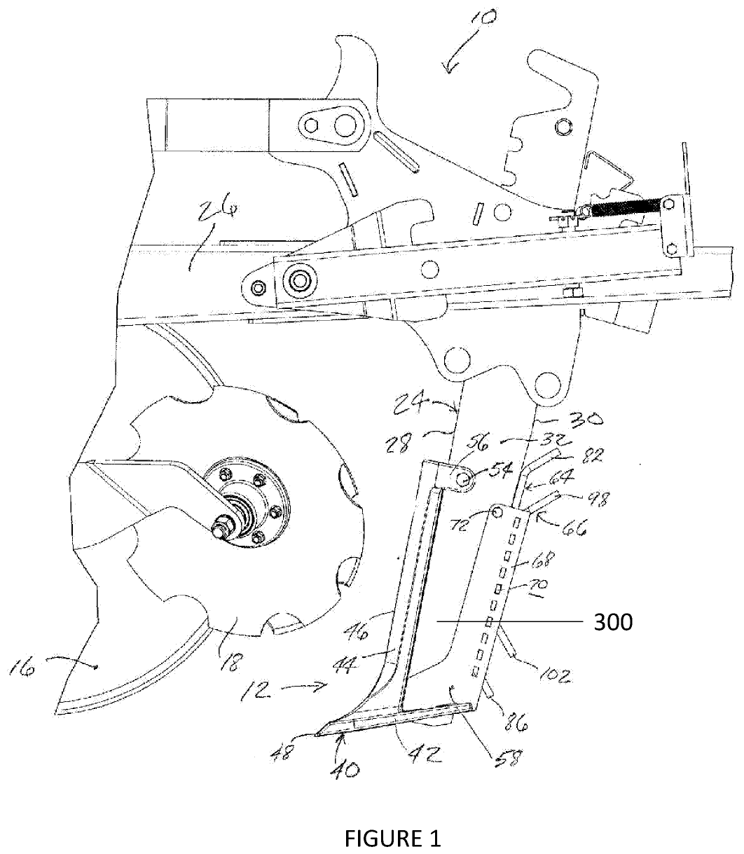

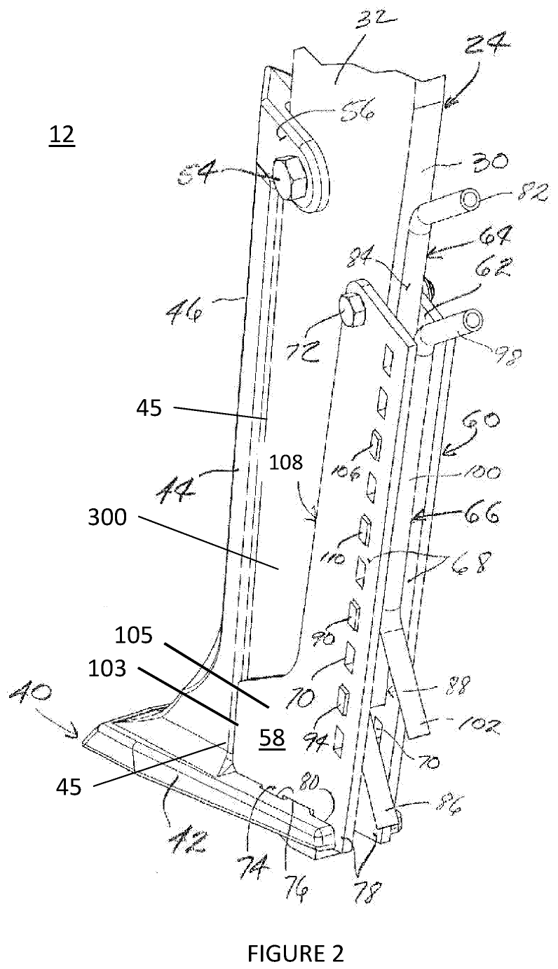

As illustrated in FIG. 3, in the area 300 of FIGS. 1 and 2, a consumable protective shin 200 is attached. The consumable protective shin 200 may fill or overlay the entire area 300 of FIGS. 1 and 2 or fill the portion of the area 300 of FIGS. 1 and 2 that is contact with the soil flows.

Thus, the consumable protective shin 200 does not need to fill or overlay the entire area 300 to effectively extend the life of the side shield plates 58 and 60 to be substantially equal to the life of the tip or point (shoe) 40.

The consumable protective shin 200 may be constructed of a plastic material or a material having a hardness less than the hardness of the side shield plates 58 and 60 or point (shoe) 40, thereby allowing the consumable protective shin 200 to be consumed (wore away from the abrasive forces of the soil flow) at a faster rate than the side shield plates 58 and 60. It is noted that the consumable protective shin 200 may be constructed of a thermoplastics, such as nylon 6/6.

Moreover, consumable protective shin 200 may be constructed of a plastic material or a material having a hardness less than the hardness of the side shield plates 58 and 60 or point (shoe) 40, thereby allowing the consumable protective shin 200 to dampen a substantial amount of the abrasive forces of the soil flow and reducing the strength of the abrasive forces interacting with the side shield plates 58 and 60.

The consumable protective shin 200 fills or overlays the area 300 of FIGS. 1 and 2 so as to create a substantially flat or smooth surface from the rear edge of the guard 44 of point (shoe) 40 to a forward edge of the side shield plates 58 and 60.

By filling or overlaying the area 300 of FIGS. 1 and 2 so as to create a substantially flat or smooth surface from the rear edge of the guard 44 of point (shoe) 40 to a forward edge of the side shield plates 58 and 60, the consumable protective shin 200 reduces the turbulence of the soil flow, thereby reducing the impact of the abrasive forces of the soil flow.

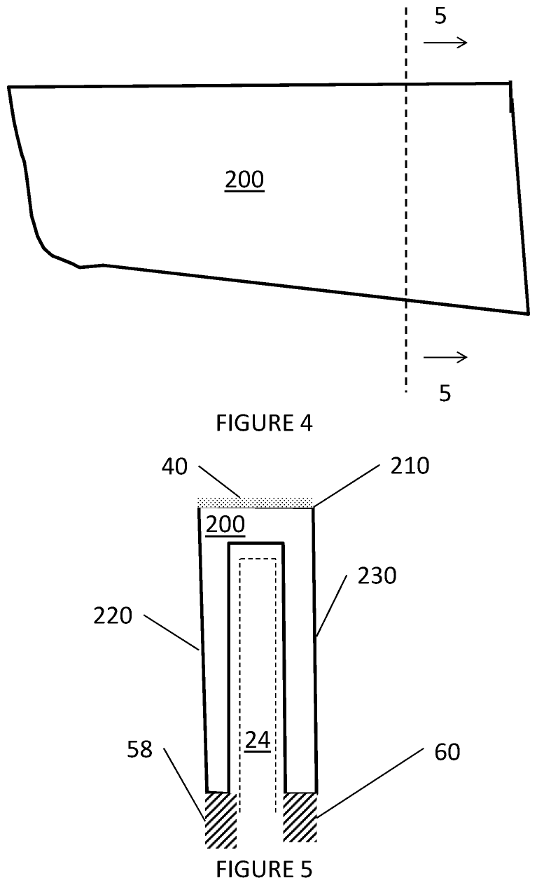

As illustrated in FIG. 4, the consumable protective shin 200 is shaped to match the boundary of the portion of the area 300 of FIGS. 1 and 2 that is being filled or overlaid.

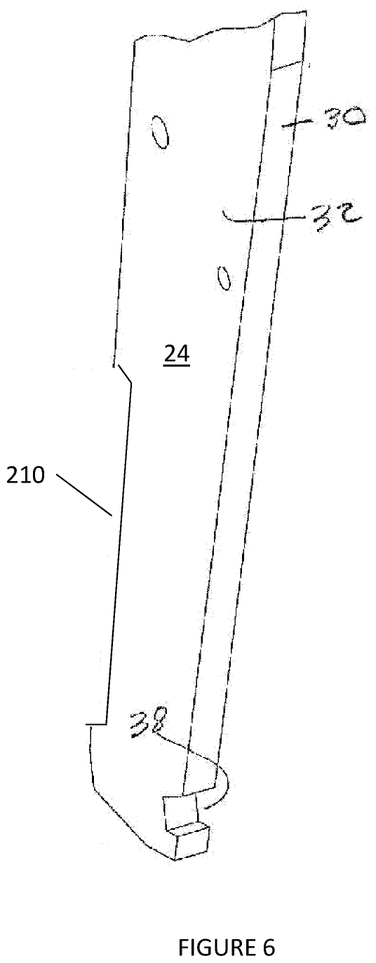

Further as illustrated in FIG. 5, the consumable protective shin 200 is shaped to include a first side 220 and a second side 230 that fill or overlay the corresponding areas 300 of FIGS. 1 and 2 on both sides of the shank 24. The consumable protective shin 200 also has a bottom 210 that overlays a front edge of the shank 24 so as to engage the notch 210 of FIG. 6. The bottom 210 and the sides 220 and 230 of the consumable protective shin 200 form substantially a U-shaped or C-shaped component.

The first side 220 and second side 230 are spaced apart so as to form a volume that receives the shank 24. The first side 220 has an edge that engages side shield plate 58, and the second side 230 has an edge that engages side shield plate 60. The bottom 210 engages the rear edge of the guard 44 of the shoe.

In other words, the first side 220 has a surface from the rear edge of the guard 44 of the shoe to a forward edge of the side shield plate 58, and the second side 230 has a surface from the rear edge of the guard 44 of the shoe to a forward edge of the side shield plate 60.

It is noted that consumable protective shin 200 may not include the bottom 210, but may be two consumable protective shin sides that are appropriately adhered to the portion of area 300 of FIGS. 1 and 2, which is to be filled or overlaid.

FIG. 6 illustrates a modified shank 24, which has a notch 210 formed on a front edge of the shank 24. The notch 210 engages a top portion of the consumable protective shin 200 of FIGS. 4 and 5.

The notch 210 secures the consumable protective shin 200 and prevents the consumable protective shin 200 from sliding up or down the shank 24 due to the forces of the soil flow.

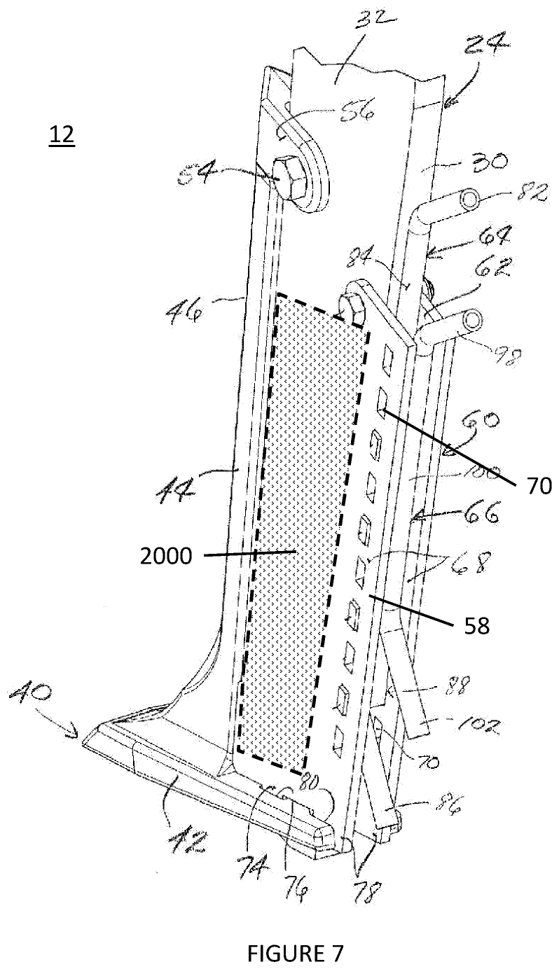

FIG. 7 illustrates another shank assembly 12 that includes an elongated, generally upright, slightly rearwardly inclined, flat shank 24. Shank 24 is rectangular in transverse cross-section, having a front edge, a flat rear edge 30, and a pair of wide, flat, left and right sides 32.

Shank assembly 12 further includes a point or shoe broadly denoted by the numeral 40 and detachably secured to shank 24. Point (shoe) 40 is designed to make the primary contacting engagement with the soil instead of shank 24 so as to avoid premature wear of shank. Thus, point (shoe) 40 is constructed of a hardened material and is designed to be a replaceable (consumable) unit.

Point (shoe) 40 is generally L-shaped when viewed in side elevation and includes a generally horizontal leg comprising a base 42 and a generally upright leg comprising a front edge guard 4 4. Guard 44 and base 42 are integrally connected parts of a single, L-shaped unit.

Shank assembly 12 further includes a pair of generally L-shaped, flat, side shield plates 58 and 60 held on opposite sides of the shank 24 and a pair of fertilizer tubes 64 and 66. Side shield plates 58 and 60 are disposed in such a position relative to shank 24 that the side shield plates project rearwardly beyond shank rear edge 30 and cooperatively define a gap or generally U-shaped channel 62 immediately behind rear edge 30. Such gap 62 is adapted to receive and protectively house a pair of generally upright delivery tubes 64 and 66 for fertilizer or other substances.

Side shield plates 58 and 60 each have a rear margin 68 that projects rearwardly beyond rear shank edge 30 for use in defining the gap 62. Additionally, each rear margin 68 includes a generally vertically extending series of rectangular holes 70 that serve as part of the means for adjustably supporting tubes 64 and 66.

As illustrated in FIG. 7, in the area 300 of FIGS. 1 and 2, a consumable protective shin 2000 is attached. The consumable protective shin 2000 may fill or overlay the entire area 300 of FIGS. 1 and 2 or fill the portion of the area 300 of FIGS. 1 and 2 that is contact with the soil flows.

Moreover, as illustrated in FIG. 7, the consumable protective shin 2000 overlays a portion of the side shield plates 58 and 60.

It is noted, that although not illustrated, the consumable protective shin 2000 may be further extended to overlay the holes 70 of the side shield plates 58 and 60.

Although FIG. 7 illustrates that the consumable protective shin 2000 or overlays substantially all the entire area 300 of FIGS. 1 and 2, the consumable protective shin 2000 does not need to fill or overlay substantially all the entire area 300 of FIGS. 1 and 2 to effectively extend the life of the side shield plates 58 and 60 to be substantially equal to the life of the tip or point (shoe) 40.

The consumable protective shin 2000 may be constructed of a plastic material or a material having a hardness less than the hardness of the side shield plates 58 and 60 or point (shoe) 40, thereby allowing the consumable protective shin 2000 to be consumed (wore away from the abrasive forces of the soil flow) at a faster rate than the side shield plates 58 and 60. It is noted that the consumable protective shin 2000 may be constructed of a thermoplastics, such as nylon 6/6.

Moreover, consumable protective shin 2000 may be constructed of a plastic material or a material having a hardness less than the hardness of the side shield plates 58 and 60 or point (shoe) 40, thereby allowing the consumable protective shin 2000 to dampen a substantial amount of the abrasive forces of the soil flow and reducing the strength of the abrasive forces interacting with the side shield plates 58 and 60.

The consumable protective shin 2000 fills or overlays the area 300 of FIGS. 1 and 2 so as to create a substantially flat or smooth surface from the rear edge of the guard 44 of point (shoe) 40 to a forward edge of the side shield plates 58 and 60.

Alternatively, the consumable protective shin 2000 may fill or overlay the area 300 of FIGS. 1 and 2 so as to create a tapered surface from the rear edge of the guard 44 of point (shoe) 40 to the edge of the consumable protective shin 2000 overlaying the side shield plates 58 and 60. In other words, the width of the consumable protective shin 2000 at its closed end, located at the rear edge of the guard 44 of point (shoe) 40, may be less than the width of the consumable protective shin 2000 at its opened end, located at the edge of the consumable protective shin 2000 overlaying the side shield plates 58 and 60.

By filling or overlaying the area 300 of FIGS. 1 and 2 so as to create a substantially flat or smooth surface (or alternatively a tapered surface) from the rear edge of the guard 44 of point (shoe) 40 to the edge of the consumable protective shin 2000 overlaying the side shield plates 58 and 60, the consumable protective shin 2000 reduces the turbulence of the soil flow, thereby reducing the impact of the abrasive forces of the soil flow.

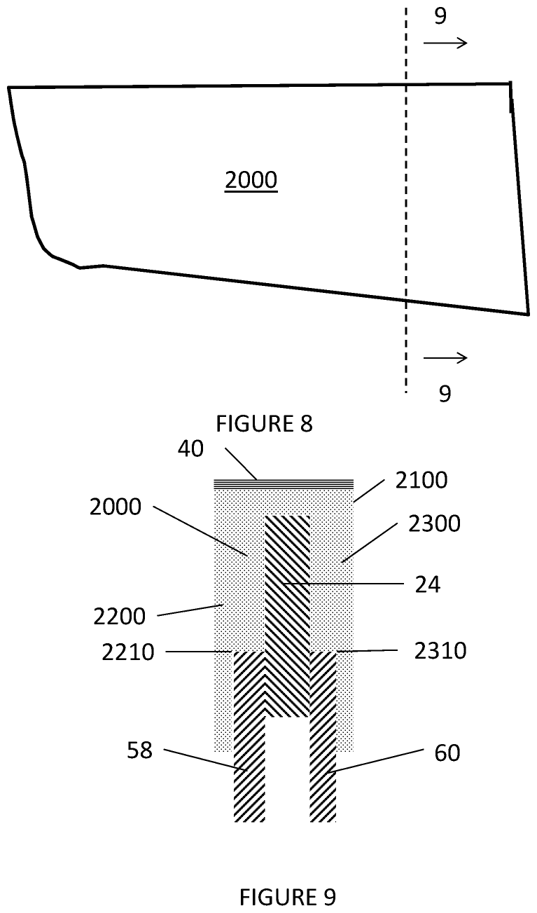

As illustrated in FIG. 8, the consumable protective shin 2000 is shaped to match the boundary of the portion of the area 300 of FIGS. 1 and 2 that is being filled or overlaid and the portion of the side shield plates 58 and 60 being overlaid.

Further as illustrated in FIG. 9, the consumable protective shin 2000 is shaped to include a first side 2200 and a second side 2300 that fill or overlay the corresponding areas 300 of FIGS. 1 and 2 on both sides of the shank 24. The consumable protective shin 2000 also has a bottom 2100 that overlays a front edge of the shank 24 so as to engage the notch 210 of FIG. 6. The bottom 2100 and the sides 2200 and 2300 of the consumable protective shin 2000 form substantially a U-shaped or C-shaped component.

The first side 2200 and second side 2300 are spaced apart so as to form a volume that receives the shank 24. The first side 2200 has a notch 2210 that engages side shield plate 58 so that a portion of the first side 2200 can overlay a portion of the side shield plate 58, and the second side 2300 has a notch 2310 that engages side shield plate 60 so that a portion of the first side 2300 can overlay a portion of the side shield plate 60. The bottom 2100 engages the rear edge of the guard 44 of the shoe.

In other words, the first side 2200 has a surface from the rear edge of the guard 44 of the shoe to a forward edge of the side shield plate 58, and the second side 2300 has a surface from the rear edge of the guard 44 of the shoe to a forward edge of the side shield plate 60.

It is noted that consumable protective shin 2000 may not include the bottom 2100, but may be two consumable protective shin sides that are appropriately adhered to the portion of area 300 of FIGS. 1 and 2, which is to be filled or overlaid.

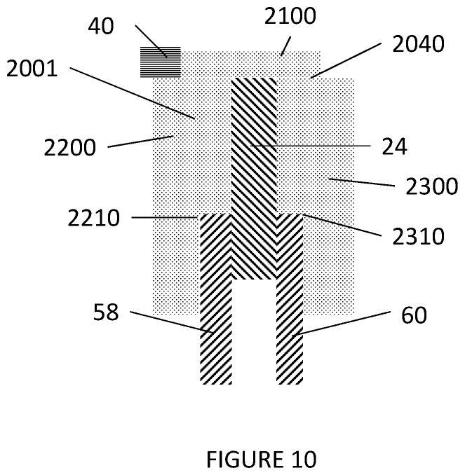

As illustrated in FIG. 10, the consumable protective shin 2001 is shaped to include a first side 2200 and a second side 2300 that fill or overlay the corresponding areas 300 of FIGS. 1 and 2 on both sides of the shank 24. The consumable protective shin 2001 also has a bottom 2100 that overlays a front edge of the shank 24 so as to engage the notch 210 of FIG. 6. The bottom 2100 and the sides 2200 and 2300 of the consumable protective shin 2001 form substantially a U-shaped or C-shaped component.

The first side 2200 and second side 2300 are spaced apart so as to form a volume that receives the shank 24. The first side 2200 has a notch 2210 that engages side shield plate 58 so that a portion of the first side 2200 can overlay a portion of the side shield plate 58, and the second side 2300 has a notch 2310 that engages side shield plate 60 so that a portion of the first side 2300 can overlay a portion of the side shield plate 60. The bottom 2100 engages the rear edge of the guard 44 of the shoe.

In other words, the first side 2200 has a surface from the rear edge of the guard 44 of the shoe to a forward edge of the side shield plate 58, and the second side 2300 has a surface from the rear edge of the guard 44 of the shoe to a forward edge of the side shield plate 60.

Consumable protective shin 2001, as illustrated in FIG. 10, may be notched 2040 in the bottom 2100 so as to engage the rear edge of the guard 44 of the shoe. This allows the notch 210 of FIG. 6 to be shallower if there is a sufficient enough gap between the shank 24 and the guard 44 of the shoe to so that the thickness of the engaged bottom 2100 can effectively holding the shin 2001 in place with the shank 24.

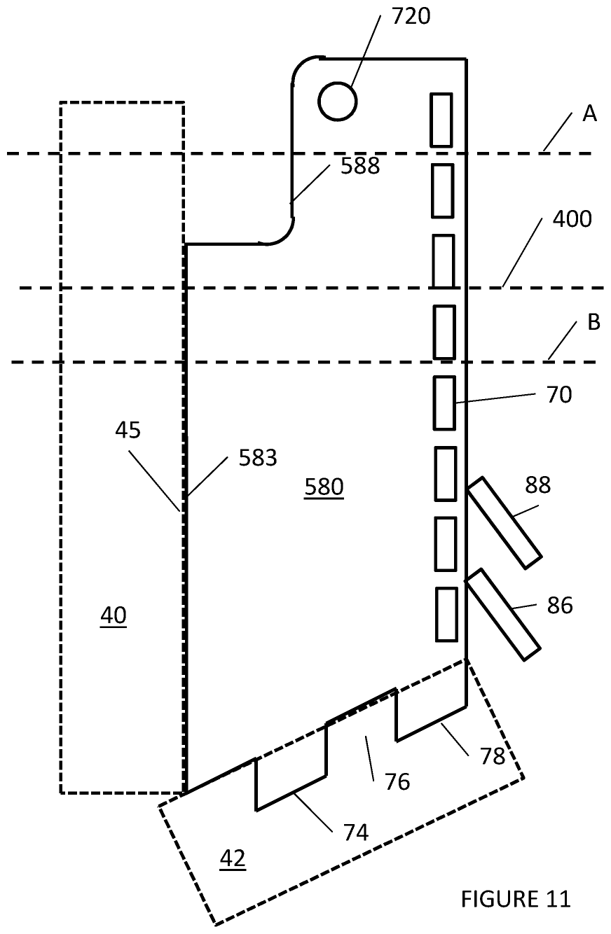

FIG. 11 illustrates a modified side plate 580. As illustrated in FIG. 11, the modified side plate 580 includes a modified side plate extension portion 583 that extends over a shank (not shown) such that a forward edge of the modified side plate extension portion 583 abuts a rear edge 45 of point (shoe) 40. The modified side plate 580 also includes projections 74 and 78 and slot 76 that engage the base 42 of point (shoe) 40 and includes a generally vertically extending series of rectangular holes (70) that serve as part of the means for adjustably supporting tubes that have discharge portions 86 and 88, as described above

The forward edge of the modified side plate extension portion 583 extends from the base 42 to above the soil line 400 so as to engage the abrasive forces of the soil flow. The modified side plate extension portion 583 covers the shank portion below the soil line 400.

The modified side plate 580 includes an attachment portion 588 that is above the soil line 400 and does not abut the rear edge 45 of point (shoe) 40. The attachment portion 588 includes opening 720 for receiving a transverse bolt (not shown) so as to attached the modified side plate 580 to the shank.

As illustrated in FIG. 11, the width of the modified side plate extension portion 583 is greater than the width of the attachment portion 588.

Although FIG. 11 illustrates that the modified side plate extension portion 583 extends from the base 42 to above the soil line 400, the modified side plate extension portion 583 may extend from the base 42 to above the discharge portion 88 of a supporting tube (not shown).

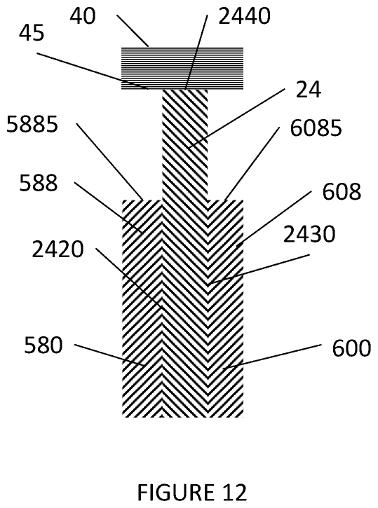

FIG. 12 shows a perspective of modified side plates, as illustrated in FIG. 11, along dotted line A. As illustrated in FIG. 12, the front edges 5885 and 6085 of the attachment portions 588 and 608 of the modified side plates 580 and 600, respectively, do not abut the rear edge 45 of point (shoe) 40. Moreover, the attachment portions 588 and 608 of the modified side plates 580 and 600, respectively, sandwich a shank 24 by engaging sides 2420 and 2430, respectively. A forward edge 2440 of the shank 24 abuts the rear edge 45 of point (shoe) 40.

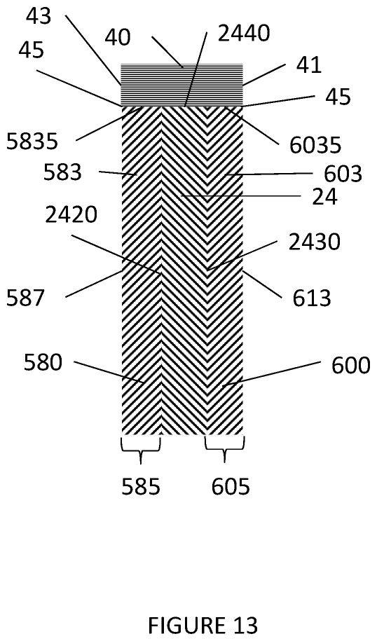

FIG. 13 shows a perspective of modified side plates, as illustrated in FIG. 11, along dotted line B. As illustrated in FIG. 13, the front edges 5835 and 6035 of the modified side plate extension portions 583 and 603 of the modified side plates 580 and 600, respectively, abut the rear edge 45 of point (shoe) 40.

Moreover, the modified side plate extension portions 583 and 603 of the modified side plates 580 and 600, respectively, sandwich a shank 24 by engaging sides 2420 and 2430, respectively. A forward edge 2440 of the shank 24 abuts the rear edge 45 of point (shoe) 40.

It is noted, as illustrated in FIG. 13, that thickness 585 of the modified side plate extension portion 583 of the modified side plate 580 may be equal to the distance (585) that the point (shoe) 40 extends out from side 2420 of the shank 24.

Moreover, it is noted, as illustrated in FIG. 13, that thickness 605 of the modified side plate extension portion 603 of the modified side plate 600 may be equal to the distance (605) that the point (shoe) 40 extends out from side 2430 of the shank 24.

As illustrated in FIG. 13, a top surface 587 of modified side plate extension portion 580 may be co-planar with a side surface 43 of the point (shoe) 40. Moreover, a top surface 613 of modified side plate extension portion 600 may be co-planar with a side surface 41 of the point (shoe) 40.

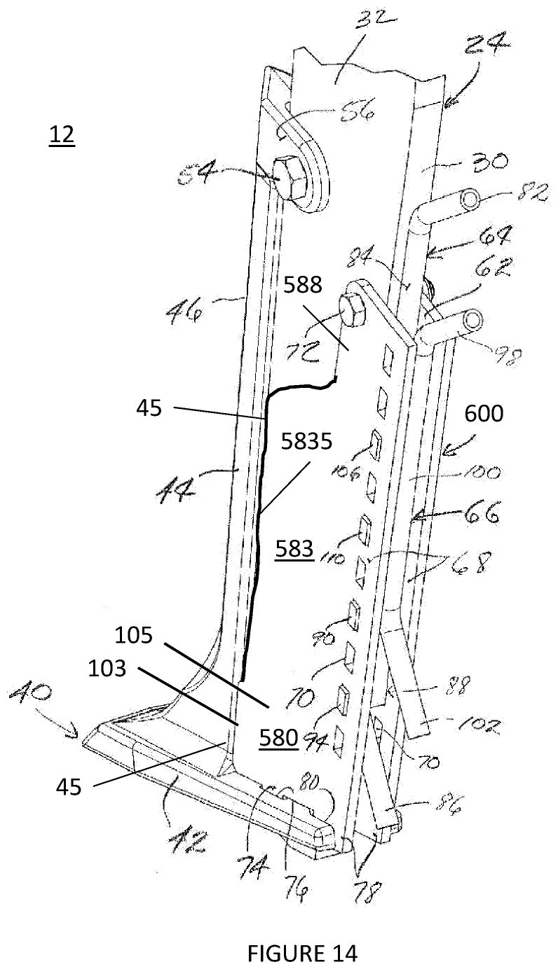

FIG. 14 shows the shank assembly of FIG. 2 with a modified side plate configured to counteract or dampen the abrasive forces of the soil flow. As illustrated in FIG. 14, shank assembly 12 includes an elongated, generally upright, slightly rearwardly inclined, flat shank 24. Shank 24 is rectangular in transverse cross-section, having a flat front edge, a flat rear edge, and a pair of wide, flat, left and right sides 32. Shank 24 also has a lowermost bottom edge and is provided with a rearwardly facing notch in the rear edge near bottom edge.

Shank assembly 12 further includes a point or shoe 40 and detachably secured to shank 24. Point (shoe) 40 is designed to make the primary contacting engagement with the soil along front edge 28 instead of shank 24 so as to avoid premature wear of front edge 28 of shank 24. Thus, point (shoe) 40 is constructed of a hardened material and is designed to be a replaceable (consumable) unit.

Point (shoe) 40 is generally L-shaped when viewed in a side elevation and includes a generally horizontal leg comprising a base 42 and a generally upright leg comprising a front edge guard 44. The point (shoe) 40 also includes a rear edge 45. Guard 44, rear edge 45, and base 42 are integrally connected parts of a single, L-shaped unit.

Guard 44 of point (shoe) 40 is slightly wider than front edge 28 of shank 24, and rear edge 45 of point (shoe) 40 butts up against front edge 28 when point (shoe) 40 is in place. A generally upright beveled leading edge 46 of guard 44 serves to cut through the soil in the slit made by a coulter and to progressively widen such slit to permit the passage therethrough of the remaining width of shank assembly 12.

As illustrated in FIG. 14, base 42 has a relatively broad, flat chisel nose 48 that progressively transitions to leading edge 46. Base 42 is also substantially wider than guard 44 and shank 24 so as to present a pair of shelf-like wing portions that lead rearwardly from chisel nose and project laterally outwardly from opposite sides of shank 24. Immediately behind guard 44 within base 42 is a centrally disposed opening (not shown) that receives the lower end portion of shank 24 and through which bottom edge projects.

A rear cross bar (not shown) defines the rear extremity of the opening and spans the two opposite wing portions of base 42 behind the opening. The notch in shank 24 receives the rear cross bar so as to properly locate base 42 relative to the lower end of shank 24 and to provide a sturdy interconnection therebetween.

At the upper end of guard 44, point (shoe) 40 is held on shank 24 by a transverse bolt 54 passing through shank 24 and a pair of ears 56 that project rearwardly from guard 44 and embrace opposite sides of shank 24.

Shank assembly 12 further includes a pair of generally L-shaped, flat, modified side shield plates 580 and 600 held on opposite sides 32 of shank 24. Plates 580 and 600 are disposed in such a position relative to shank 24 that modified side plates 580 and 600 project rearwardly beyond shank rear edge and cooperatively define a gap or generally U-shaped channel 62 immediately behind rear edge. Such gap 62 is adapted to receive and protectively house a pair of generally upright delivery tubes 64 and 66 for fertilizer or other substances.

Modified side plates 580 and 600 each have a rear margin 68 that projects rearwardly beyond rear shank edge 30 for use in defining the gap 62. Additionally, each rear margin 68 includes a generally vertically extending series of rectangular holes (70) that serve as part of the means for adjustably supporting tubes 64 and 66 as explained in more detail below.

The upper ends of modified side plates 580 and 600 are secured to shank 24 by a common transverse bolt 72 at an attachment portion 588 of modified side plate 580. This location is normally above the surface of the ground when the shank assembly is in use.

As illustrated in FIG. 14, modified side plate 580 includes a modified side plate extension portion 583, which includes the conventional front projection 105 that extends towards the rear edge 45 of the point (shoe) 40. The modified side plate extension portion 583 has a front edge 5835 that abuts the rear edge 45 of the point (shoe) 40 when the modified side plate 580 and the point (shoe) 40 engage the shank 24. The front edge 5835 includes the conventional front edge 103.

As illustrated in FIG. 14, the modified side plate 580 has been modified to extend the front projection to cover the area 300 (FIG. 2) of the shank 24 behind the point (shoe) 40 and in front of the conventional side plate 58 of FIG. 2.

As noted above, the valley shape of the area 300 causes the forward edge of the conventional side plates (shields for the fertilizer tubes) to be subjected to the abrasive forces of the soil flow, thereby negatively impacting the integrity of the conventional side plates (shields for the fertilizer tubes). This situation eventually allows the abrasive forces of the soil flow to enter the fertilizer (material) delivery tube “chamber” and negatively impact the integrity of the actual fertilizer tubes.

To dampen, reduce, or eliminate abrasive forces from soil flow, modified side plate extension portion 583 covers the area 300 of FIG. 2.

In other words, modified side plate extension portion 583 covers more of the shank 24 than the conventional front projection 105 of FIG. 2 to dampen, reduce, or eliminate abrasive forces from soil flow impacting the shank and/or the integrity of the actual fertilizer tubes.

In summary, a consumable protective shin is mounted onto or attached to the shank of a tilling device in the area from the rear edge of the guard of the shoe to a forward edge of the side shield plates to fill or overlay this area.

Alternatively, a consumable protective shin is mounted onto or attached to the shank of a tilling device in the area from the rear edge of the guard of the shoe to an edge of the consumable protective shin which overlays a portion of the side shield plates.

The inclusion of the consumable protective shin dampens a substantial amount of the abrasive forces of the soil flow and reduces the strength of the abrasive forces interacting with the side shield plates.

The inclusion of the consumable protective shin also allows the consumable protective shin to be consumed (wore away from the abrasive forces of the soil flow) at a faster rate than the side shield plates, thereby extending the effective life of the side shield plates.

The consumable protective shin can be easily replaced by disengaging the shoe from the shank, removing the “consumed” consumable protective shin, placing a new consumable protective shin therein, and re-engaging the shoe to the shank. This operation can be done in the field and does not require the removal of the tilling device from the tractor.

In addition, the utilization of the consumable protective shin can extend the effective life of the side shield plates so that the effective life of the side shield plates substantially outlasts the effective life of the shoe.

Moreover, by constructing the consumable protective shin of a plastic material, it can be inexpensively manufactured compared to the manufacturing costs of the side shield plates. Thus, the consumption of the consumable protective shins over the multiple replacements of the side shield plates per replacement of the shoe effectively reduces the overall costs of materials utilized per unit acre plowed.

A protective shin for a tillage shank comprises an integral U-shaped shin having a first side, a second side, and a bottom; the first side and the second side being spaced apart to form a volume therebetween; the first side having a first side surface having first side length and a first side width; the second side having a second side surface having a second side length and a second side width; the first side length being from a rear edge of a guard of a shoe engaging the tillage shank to a forward edge of a first side shield engaging the tillage shank; the second side length being from the rear edge of the guard of the shoe engaging the tillage shank to a forward edge of a second side shield engaging the tillage shank.

The integral U-shaped shin may be constructed of a material having a hardness less than a hardness of the side shields. The integral U-shaped shin may be constructed of a material having a hardness less than a hardness of the guard of the shoe.

The integral U-shaped shin may be constructed of a plastic. The integral U-shaped shin may be constructed of a thermoplastic. The integral U-shaped shin may be constructed of a nylon.

A protective shin for a tillage shank, comprises an integral U-shaped shin having a first side, a second side, and a bottom; the first side and the second side being spaced apart to form a volume therebetween; the first side having a first side surface having first side length and a first side width; the second side having a second side surface having a second side length and a second side width; the first side having a first side notch for engaging a forward edge of a first side shield engaging the tillage shank; the second side having a second side notch for engaging a forward edge of a second side shield engaging the tillage shank; the first side length being from a rear edge of a guard of a shoe engaging the tillage shank to a location on the first side shield engaging the tillage shank such that the first side overlays a portion of the first side shield engaging the tillage shank; the second side length being from a rear edge of a guard of a shoe engaging the tillage shank to a location on the second side shield engaging the tillage shank such that the second side overlays a portion of the second side shield engaging the tillage shank.

The integral U-shaped shin may be constructed of a material having a hardness less than a hardness of the side shields. The integral U-shaped shin may be constructed of a material having a hardness less than a hardness of the guard of the shoe.

The integral U-shaped shin may be constructed of a plastic. The integral U-shaped shin may be constructed of a thermoplastic. The integral U-shaped shin may be constructed of a nylon.

A tillage shank assembly comprises a tillage shank; a shoe; a first side shield; a second side shield; and a protective shin; the shank tillage having a notch to engage the protective shin.

The protective shin may be integral and U-shaped, having a first side, a second side, and a bottom; the first side and the second side being spaced apart to form a volume therebetween; the first side having a first side surface having first side length and a first side width; the second side having a second side surface having a second side length and a second side width; the first side length being from a rear edge of a guard of the shoe engaging the tillage shank to a forward edge of the first side shield engaging the tillage shank; the second side length being from the rear edge of the guard of the shoe engaging the tillage shank to a forward edge of the second side shield engaging the tillage shank.

The protective shin may be constructed of a material having a hardness less than a hardness of the first side shield and having a hardness less than a hardness of the second side shield.

The protective shin may be constructed of a plastic. The protective shin may be constructed of a thermoplastic. The protective shin may be constructed of a nylon.

A side plate configured for a tillage shank having a point on a forward edge of the tillage shank and a point base on a bottom edge of the tillage shank to dampen abrasive forces from soil flow, comprises a modified side plate extension portion having a modified side plate extension portion front edge, the modified side plate extension portion being configured such that the modified side plate extension portion front edge abuts a rear edge of the point on the forward edge of the tillage shank from the point base on the bottom edge of the tillage shank to above a soil line; a attachment portion having a attachment portion front edge, the attachment portion being configured such that the attachment portion front edge does not abut the rear edge of the point on the forward edge of the tillage shank above the soil line; a projection configured to engage the point base on the bottom edge of the tillage shank; a slot configured to engage the point base on the bottom edge of the tillage shank; and an opening configured to receive a transverse bolt when attaching the side plate to the tillage shank.

The modified side plate extension portion front edge may have a thickness equal to a distance corresponding to the point extending out from a side of the shank.

A top surface of the modified side plate extension portion may be co-planar with a side surface of the point.

The side plate may further comprise a plurality of openings configured to support fertilizer tubes.

A tillage shank assembly comprises a tillage shank; a point abutting a forward edge of the tillage shank and having a point base to abut a bottom edge of the tillage shank; a first side plate; and a second side plate; the first side plate including a first modified side plate extension portion having a first modified side plate extension portion front edge, the first modified side plate extension portion being configured such that the first modified side plate extension portion front edge abuts a rear edge of the point from the point base to above a soil line, a first attachment portion having a first attachment portion front edge, the first attachment portion being configured such that the first attachment portion front edge does not abut the rear edge of the point above the soil line, a first projection configured to engage the point base, a first slot configured to engage the point base, and a first opening configured to receive a transverse bolt when attaching the first side plate to the tillage shank; the second side plate including a second modified side plate extension portion having a second modified side plate extension portion front edge, the second modified side plate extension portion being configured such that the second modified side plate extension portion front edge abuts a rear edge of the point from the point base to above a soil line, a second attachment portion having a second attachment portion front edge, the second attachment portion being configured such that the second attachment portion front edge does not abut the rear edge of the point above the soil line, a second projection configured to engage the point base, a second slot configured to engage the point base, and a second opening configured to receive a transverse bolt when attaching the second side plate to the tillage shank.

The first modified side plate extension portion front edge may have a thickness equal to a distance corresponding to the point extending out from a side of the shank. The second modified side plate extension portion front edge may have a thickness equal to a distance corresponding to the point extending out from a side of the shank.

A top surface of the first modified side plate extension portion may be co-planar with a side surface of the point. A top surface of the second modified side plate extension portion may be co-planar with a side surface of the point.

The tillage shank assembly may further comprise fertilizer tubes.

The first side plate may include a plurality of first openings configured to support the fertilizer tubes. The second side plate may include a plurality of second openings configured to support the fertilizer tubes.

A tillage shank assembly comprises a tillage shank having a first side and a second side; a removable shoe with a soil cutting surface, a rear edge, and a base edge; the removable shoe being removable from the tillage shank; a first side shield with a first side shield front edge and a first side shield bottom side; and a non-soil cutting shin having a first side, a second side, a third side, a fourth side, a fifth side, and a sixth side; the fifth side of the non-soil cutting shin being orthogonal to the first side, the second side, the third side, and the fourth side of the non-soil cutting shin; the sixth side of the non-soil cutting shin being orthogonal to the first side, the second side, the third side, and the fourth side of the non-soil cutting shin; the non-soil cutting shin being configured such that the first side of the non-soil cutting shin abuts the rear edge of the removable shoe; the non-soil cutting shin being configured such that the second side of the non-soil cutting shin abuts the first side shield bottom side; the non-soil cutting shin being configured such that the third side of the non-soil cutting shin abuts the first side shield front edge; the non-soil cutting shin being configured such that the fifth side of the non-soil cutting shin abuts the first side of the tillage shank; the non-soil cutting shin being configured such that the sixth side of the non-soil cutting shin dampens abrasive forces from soil flow.

The non-soil cutting shin may be constructed of a metal, a plastic, a thermoplastic, or a nylon.

It will be appreciated that several of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above.

What is claimed is:

1. A side plate configured for a tillage shank having a point on a forward edge of the tillage shank and a point base on a bottom edge of the tillage shank to dampen abrasive forces from soil flow, comprising:
a modified side plate extension portion having a modified side plate extension portion front edge, said modified side plate extension portion being configured such that said modified side plate extension portion front edge abuts a rear edge of the point on the forward edge of the tillage shank from the point base on the bottom edge of the tillage shank to above a soil line;
an attachment portion having an attachment portion front edge, said attachment portion being configured such that said attachment portion front edge does not abut the rear edge of the point on the forward edge of the tillage shank above the soil line;
a projection configured to engage the point base on the bottom edge of the tillage shank;
a slot configured to engage the point base on the bottom edge of the tillage shank; and
an opening configured to receive a transverse bolt when attaching the side plate to the tillage shank.

2. The side plate as claimed in claim 1, wherein said modified side plate extension portion front edge has a thickness equal to a distance corresponding to the point extending out from a side of the shank.

3. The side plate as claimed in claim 1, wherein a top surface of said modified side plate extension portion is co-planar with a side surface of the point.

4. The side plate as claimed in claim 1, further comprising:
a plurality of openings configured to support fertilizer tubes.

5. A tillage shank assembly comprising:
a tillage shank;
a point abutting a forward edge of said tillage shank and having a point base to abut a bottom edge of said tillage shank;
a first side plate; and
a second side plate;
said first side plate including
a first modified side plate extension portion having a first modified side plate extension portion front edge, said first modified side plate extension portion being configured such that said first modified side plate extension portion front edge abuts a rear edge of said point from said point base to above a soil line,
a first attachment portion having a first attachment portion front edge, said first attachment portion being configured such that said first attachment portion front edge does not abut the rear edge of said point above the soil line,
a first projection configured to engage said point base,
a first slot configured to engage said point base, and
a first opening configured to receive a transverse bolt when attaching said first side plate to said tillage shank;
said second side plate including
a second modified side plate extension portion having a second modified side plate extension portion front edge, said second modified side plate extension portion being configured such that said second modified side plate extension portion front edge abuts a rear edge of said point from said point base to above a soil line,
a second attachment portion having a second attachment portion front edge, said second attachment portion being configured such that said second attachment portion front edge does not abut the rear edge of said point above the soil line,
a second projection configured to engage said point base,
a second slot configured to engage said point base, and
a second opening configured to receive a transverse bolt when attaching said second side plate to said tillage shank.

6. The tillage shank assembly as claimed in claim 5, wherein said first modified side plate extension portion front edge has a thickness equal to a distance corresponding to said point extending out from a side of said shank;
said second modified side plate extension portion front edge having a thickness equal to a distance corresponding to said point extending out from a side of said shank.

7. The tillage shank assembly as claimed in claim 5, wherein a top surface of said first modified side plate extension portion is co-planar with a side surface of the point;
a top surface of said second modified side plate extension portion being co-planar with a side surface of the point.

8. The tillage shank assembly as claimed in claim 5, further comprising fertilizer tubes.

9. The tillage shank assembly as claimed in claim 8, wherein said first side plate includes a plurality of first openings configured to support said fertilizer tubes;
said second side plate includes a plurality of second openings configured to support said fertilizer tubes.

10. A tillage shank assembly comprising:
a tillage shank having a first side and a second side;
a removable shoe with a soil cutting surface, a rear edge, and a base edge;
said removable shoe being removable from said tillage shank;
a first side shield with a first side shield front edge and a first side shield bottom side; and
a non-soil cutting shin having a first side, a second side, a third side, a fourth side, a fifth side, and a sixth side;
said fifth side of said non-soil cutting shin being orthogonal to said first side, said second side, said third side, and said fourth side of said non-soil cutting shin;
said sixth side of said non-soil cutting shin being orthogonal to said first side, said second side, said third side, and said fourth side of said non-soil cutting shin;
said non-soil cutting shin being configured such that said first side of said non-soil cutting shin abuts said rear edge of said removable shoe;
said non-soil cutting shin being configured such that said second side of said non-soil cutting shin abuts said first side shield bottom side;
said non-soil cutting shin being configured such that said third side of said non-soil cutting shin abuts said first side shield front edge;
said non-soil cutting shin being configured such that said fifth side of said non-soil cutting shin abuts said first side of said tillage shank;
said non-soil cutting shin being configured such that said sixth side of said non-soil cutting shin dampens abrasive forces from soil flow.

11. The tillage shank assembly as claimed in claim 10, wherein said non-soil cutting shin is constructed of metal.

12. The tillage shank assembly as claimed in claim 10, wherein said non-soil cutting shin is constructed of a plastic.

13. The tillage shank assembly as claimed in claim 10, wherein said non-soil cutting shin is constructed of a thermoplastic.

14. The tillage shank assembly as claimed in claim 10, wherein non-soil cutting shin is constructed of a nylon.
